(19) United States
(12) Patent Application Publication
(10) Pub. No.: US 2009/0244772 A1
(43) Pub. Date: Oct. 1, 2009

(54) MAGNETIC HEAD SUBSTRATE, MAGNETIC HEAD AND RECORDING MEDIUM DRIVING DEVICE

(75) Inventors: Toshiyuki Sue, Kirishima (JP); Masahiro Nakahara, Kirishima (JP); Takuya Gentsuu, Kirishima (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, KYOTO (JP)

(21) Appl. No.: 12/280,974

(22) PCT Filed: Feb. 26, 2007
(86) PCT No.: PCT/JP2007/053556

§ 371 Date: May 19, 2009

(30) Foreign Application Priority Data
Feb. 27, 2006 (JP) 2006-050968

(51) Int. Cl. G11B 5/127; H01B 1/04

(52) U.S. Cl. 360/110; 252/516; G9B/5.04

(57) ABSTRACT

The present invention relates to a magnetic head substrate comprising a sintered body containing 35% by mass to 60% by mass of alumina and 40% by mass to 65% by mass of a conductive compound. The conductive compound contains at least one selected from carbide, nitride and carbonitride of tungsten. The sintered body has a maximum crystal particle size of 4 μm or less (except for 0 μm). Furthermore, the present invention provides a magnetic head provided with a slider formed of the magnetic head substrate and a recording medium driving device provided with the magnetic head.

### TECHNICAL FIELD

The present invention relates to a recording medium driving device such as a hard disk drive or a tape drive, a magnetic head used therefor, and a magnetic head substrate for forming a slider as a substrate of the magnetic head.

### BACKGROUND ART

A magnetic head using a magnetic thin film has been used as a recording/reproducing magnetic head of a high-density magnetic disk. Such a magnetic head has been required to have excellent wear resistance, surface smoothness of a flying surface, machinability and the like.

In order to produce such a magnetic head, first, a base film made of amorphous alumina is formed on a ceramic substrate made of Al₂O₃—TiC-based ceramics by a sputter method, and an electromagnetic converter element is mounted on the base film. The electromagnetic converter element exhibits a magnetoresistance effect. As such an electromagnetic converter element, for example, an MR (Magnetro Resistive) element (hereinafter, referred to as an “MR element”), a GMR (Giant Magnetro Resistive) element (hereinafter, referred to as a “GMR element”), or a TMR (Tunnel Magnetro Resistive) element (hereinafter, referred to as a “TMR element”) is used.

Next, the ceramic substrate on which the electromagnetic converter element is mounted is cut into strips of, and the cut surface is polished into a mirror surface. The mirror surface is then partially removed to form a recess part. The recess part is formed by an ion milling method or a reactive ion etching method. The ceramic substrates cut into strips of are divided into chips to obtain magnetic heads. In the magnetic head thus obtained, the mirror surface remaining without being removed is a flying surface opposite to a magnetic recording medium. The recess part functions as a flow channel allowing air for flying the magnetic head to pass.

The recording medium driving device has been recently required to increase the record density of a recording medium. In order to responds to this demand, the flying amount (clearance) of the magnetic head to the recording medium must be extremely reduced to 10 nm or less. However, the reduced flying amount of the magnetic head increases relatively the influence of heat generated from a coil of the electromagnetic converter element in the magnetic head to problematically destroy recording saved in the recording medium.

On the other hand, as a material forming a slider (magnetic head substrate) in the magnetic head, an alumina-based composite ceramic has been used. Various alumina-based composite ceramics have been proposed (for example, see Patent Documents 1 to 4).

Patent Document 1 discloses an alumina-based composite ceramic obtained by dispersing titanium nitride fine particles having a particle size of 2.0 μm or less in alumina crystal particles having crystal particles of 0.5 μm to 100 μm. This alumina-based composite ceramic intends enhanced strength and heat resistance.

Patent Document 2 discloses an alumina-based composite ceramic comprising a sintered body containing 10 to 25% by weight of titanium nitride and having a relative density of 96% or more and a volume resistance controlled to a range of 1×10⁴ to 5×10⁶ Ω·cm, the sintered body obtained by uniformly dispersing titanium nitride ultrafine particles in alumina crystal particles. This alumina-based composite ceramic intends high strength and density and optimized specific resistance.

Patent Document 3 discloses an alumina-based composite ceramic comprising 77 to 96% by volume of alumina particles and 4 to 23% by volume of particles made of at least one conductive compound selected from the group consisting of titanium carbide, titanium nitride, zirconium carbide, zirconium nitride, hafnium carbide, hafnium nitride, niobium carbide, niobium nitride, tantalum carbide and tantalum nitride. The alumina-based composite ceramic comprises the alumina particles and the particles made of the conductive compound which have a mean particle sizes of 5 μm or less, and has a surface resistivity of 10⁶ to 10¹⁰ Ω·cm². The alumina-based composite ceramic usefully removes the electrification of electronic components.

Patent Document 4, which exemplifies various magnetic head ceramics, exemplifies an alumina/tungsten carbide sintered body as an alumina-based composite material.

### Patent Document 1: Japanese Patent Application Laid-Open Publication No.

### Patent Document 2 Japanese Patent Application Laid-Open Publication No.

### Patent Document 3: Japanese Patent No. 3313380

### Patent Document 4: Japanese Patent Application Laid-Open Publication No.

### DISCLOSURE OF THE INVENTION

### Problems to be Solved by the Invention

However, the alumina-based composite ceramics disclosed in Patent Documents 1 to 3 do not intend to be used as a slider material of the magnetic head. The alumina-based composite ceramics are difficult to use as the magnetic head.

That is, the alumina-based composite ceramic disclosed in Patent Document 1 has high strength and thermal shock resistance, and enhanced fracture toughness. Therefore, the alumina-based composite ceramic, which has low machinability, is difficult to process to the magnetic head from the magnetic head substrate.

The alumina-based composite ceramics disclosed in Patent Documents 2 and 3 are high-density composite ceramics. However, since the alumina-based composite ceramics have too low conductivity to be used for the magnetic head.

As described above, since the alumina-based composite ceramics proposed in Patent Documents 1 to 3 have problematically low machinability or conductivity, the alumina-based composite ceramics cannot be used as the magnetic head.

By contrast, the alumina/tungsten carbide sintered body disclosed in Patent Document 4 is used for the magnetic head. However, the alumina/tungsten carbide sintered body has problematically poor machinability. That is, since tungsten has a specific gravity larger than that of alumina, a raw material powder of tungsten is hardly mixed with that of alumina uniformly in blending the raw material powders in a manufacturing process, and precipitation aggregation or the like tends to be generated. Therefore, an aggregation defect tends to be generated in the obtained magnetic head substrate. Since this aggregation defect is generated, the magnetic head cannot be produced with a high machining precision using the magnetic head substrate in an ion milling method. As a result, it is difficult to control the flying surface of the magnetic head to desired surface roughness, and it is difficult to hold the flying amount of the magnetic head constant. In particular, the sintered body cannot be used as a reduced-height magnetic head.

It is an object of the present invention to provide a material for a magnetic head having both machinability and conductivity.

### Means for Solving the Problems

A first aspect of the present invention provides a magnetic head substrate comprising a sintered body containing 35% by mass to 60% by mass of alumina and 40% by mass to 65% by mass of a conductive compound, the conductive compound containing at least one selected from carbide, nitride and carbonitride of tungsten, and the sintered body having a maximum crystal particle size of 4 μm or less (except for 0 μm).

A second aspect of the present invention provides a magnetic head comprising a slider and an electromagnetic converter element, the slider comprising a sintered body containing 35% by mass to 60% by mass of alumina and 40% by mass to 65% by mass of a conductive compound, the conductive compound containing at least one selected from carbide, nitride and carbonitride of tungsten, and the sintered body having a maximum crystal particle size of 4 μm or less (except for 0 μm).

The slider has a flying surface and a recess part for introducing air. It is preferable that the recess part has a surface having an arithmetic mean height Ra of 20 nm or less.

A third aspect of the present invention provides a recording medium driving device provided with: the magnetic head according to the second aspect of the present invention; a recording medium having a magnetic recording layer in which information is recorded and reproduced by the magnetic head; and a motor driving the recording medium.

It is preferable that the sintered body has a mean crystal particle size of 1 μm or less (except for 0 μm).

It is preferable that the alumina has a mean crystal particle size of 1 μm or less (except for 0 μm).

It is preferable that the conductive compound is the carbide of tungsten. It is preferable that the conductive compound, which has a mean crystal particle size of 10 nm (0.01 μm) to 1 μm, contains wedge-shaped particles.

In the magnetic head substrate and the magnetic head of the present invention, a distribution density of crystal particles made of the conductive compound is 5×10⁵ particles/mm² or more in a surface being parallel with a principal surface on which an electromagnetic converter element is formed and included in a region between the principal surface and a surface positioned at a depth of 1 mm from the principal surface.

The sintered body has a heat conductivity of 30 W/(m·k) or more, for example. For example, the sintered body has a flexural strength of 700 MPa or more.

### EFFECTS OF THE INVENTION

The magnetic head substrate of the present invention, which comprises the sintered body containing 35% by mass to 60% by mass of the alumina and 40% by mass to 65% by mass of the conductive compound, and the conductive compound containing at least one selected from the carbide, nitride and carbonitride of tungsten, can maintain conductivity appropriately. In addition, since the sintered body has the maximum crystal particle size of 4 μm or less (except for 0 μm), the aggregation of the alumina and the conductive compound can be suppressed and the organization thereof can be uniformized to make machinability good. Therefore, a magnetic head which has a machining processed surface having desired surface roughness and has excellent flying characteristics can be provided.

The magnetic head of the present invention can maintain conductivity appropriately and make machinability good to exhibit excellent flying characteristics since the slider has the same composition and organization state as those of the magnetic head substrate.

When a conductive compound made of the carbide of tungsten is used as the conductive compound in the magnetic head substrate and the slider of the magnetic head of the present invention, since the carbide of tungsten is more inexpensive than the nitride and carbonitride of tungsten, the carbide of tungsten is advantageous in terms of manufacturing costs. In addition, the use of the carbide of tungsten as the conductive compound can ensure the large resistance between particles and a tungsten compound when polishing the magnetic head substrate or divided pieces thereof. Thereby, the wrapping rate of the magnetic head substrate or the divided pieces thereof can be enhanced.

When the crystal particles made of the conductive compound contains the wedge-shaped particles in the magnetic head substrate and the slider of the magnetic head of the present invention, an anchor effect of the crystal particles made of the conductive compound to the crystal phase of the alumina can suppress the drop of the crystal particles made of the alumina and crystal particles made of the conductive compound when producing the magnetic head. Therefore, since the magnetic head substrate of the present invention has excellent machinability and the machining processed surface has desired surface roughness, the flying amount of the magnetic head can be stabilized.

When the mean crystal particle size of the conductive compound is set to 10 nm (0.01 μm) to 1 μm in the magnetic head substrate and the slider of the magnetic head of the present invention, the resistance value of the overall magnetic head substrate and slider can be uniformized and the volume resistance thereof can be reduced to 1 Ω·cm or less.

The distribution density of crystal particles made of the conductive compound is 5×10⁵ particles/mm² or more in the surface being parallel with the principal surface or the end face on which the electromagnetic converter element is formed and included in the region between the principal surface or the end face and a surface positioned at a depth of 1 mm from the principal surface or the end face in the magnetic head substrate and the slider of the magnetic head of the present invention. This can make the machinability better since the organization is uniformized. In addition, since an electrified area in the end face of the slider is decreased (dispersed) while the conductivity is appropriately maintained, the generation of static electricity can be suppressed. Furthermore, since the distribution density of 5×10⁵ particles/mm² or more makes the heat dissipation of the crystal particles of the conductive compound good, the heat dissipation of the overall sintered body can be also enhanced.

When the heat conductivity is set to 30 W/(m·k) or more in the magnetic head substrate and the slider of the magnetic head of the present invention, the heat generated from a coil of the electromagnetic converter element in the magnetic head can be promptly transferred. Thereby, the destruction of recording saved in the recording medium by heat can be suppressed.

When the flexural strength is set to 700 MPa or more in the magnetic head substrate and the slider of the magnetic head of the present invention, micro-cracks can be appropriately prevented. As a result, the drop of the alumina and the conductive compound can be suppressed, and thereby a magnetic head having good CSS (contact start stop) characteristics can be obtained.

When the arithmetic mean height Ra of the surface of the recess part in the slider is set to 20 nm or less (except for 0 nm) in the magnetic head of the present invention, the smoothness of the recess part is enhanced, and thereby the flying characteristics can be stabilized.

The flying characteristics of the magnetic head are stable in the recording medium driving device of the present invention. Thereby, even if the slider is miniaturized, the flying amount thereof can be held constant, and information can be correctly recorded and reproduced over a long period of time.

### BRIEF DESCRIPTION OF THE DRAWINGS

FIG. 1 is a plan view showing an example of a recording medium driving device according to the present invention.

FIG. 2 is a sectional view taken along line II-II in FIG. 1.

FIG. 3 is a sectional view taken along line III-III in FIG. 1.

FIG. 4 is an overall perspective view showing an example of a magnetic head according to the present invention.

FIG. 5 is a schematic view showing an organization structure of a slider of a magnetic head and a magnetic head substrate according to the present invention.

FIG. 6 is a schematic view of crystal particles made of a wedge-shaped conductive compound.

FIG. 7A is a perspective view for describing manufacturing steps of the magnetic head substrate.

FIG. 7B is a perspective view of a set substrate for describing a step of forming an electromagnetic converter element on the magnetic head substrate.

FIG. 8A is a perspective view for describing a step of cutting the magnetic head substrate to obtain strip pieces.

FIG. 8B is a perspective view for describing a step of cutting the magnetic head substrate to obtain strip pieces.

FIG. 9 is a perspective view showing a schematic configuration of a lap device used for polishing the strip pieces.

FIG. 10 is a front view partially showing the section of the lap device shown in FIG. 9.

FIG. 11 is a perspective view for describing a step of forming recess parts in the strip piece.

FIG. 12 is a perspective view for describing a step of cutting the strip pieces to obtain a magnetic head.

FIG. 13 is a perspective view showing a state where divided pieces of the magnetic head substrate are arranged on a lapping jig of the lap device shown in FIG. 10.

### DESCRIPTION OF THE REFERENCE NUMERALS

1: Hard disk drive (recording medium driving device)
2: Magnetic head
20: Electromagnetic converter element (of magnetic head)
21: Slider (of magnetic head)
22: Flying surface (of slider)
23: Recess part (of slider)
24: End face (of slider)
3A, 3B: Magnetic disk (recording medium)
40: Motor
6: Sintered body
61: Crystal particle of conductive compound
7: Magnetic head substrate
70: Principal surface (of magnetic head substrate)

### BEST MODE FOR CARRYING OUT THE INVENTION

Hereinafter, the present invention will be specifically described with reference to the drawings.

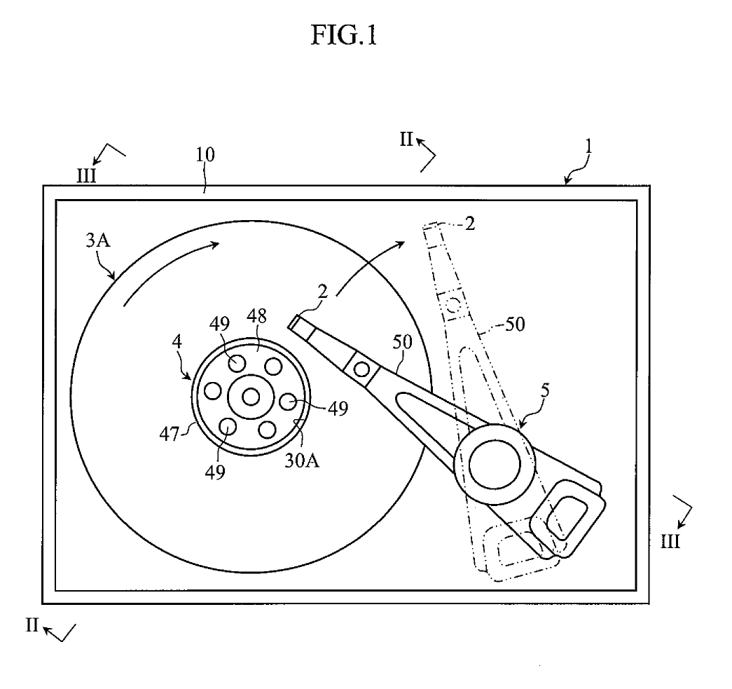

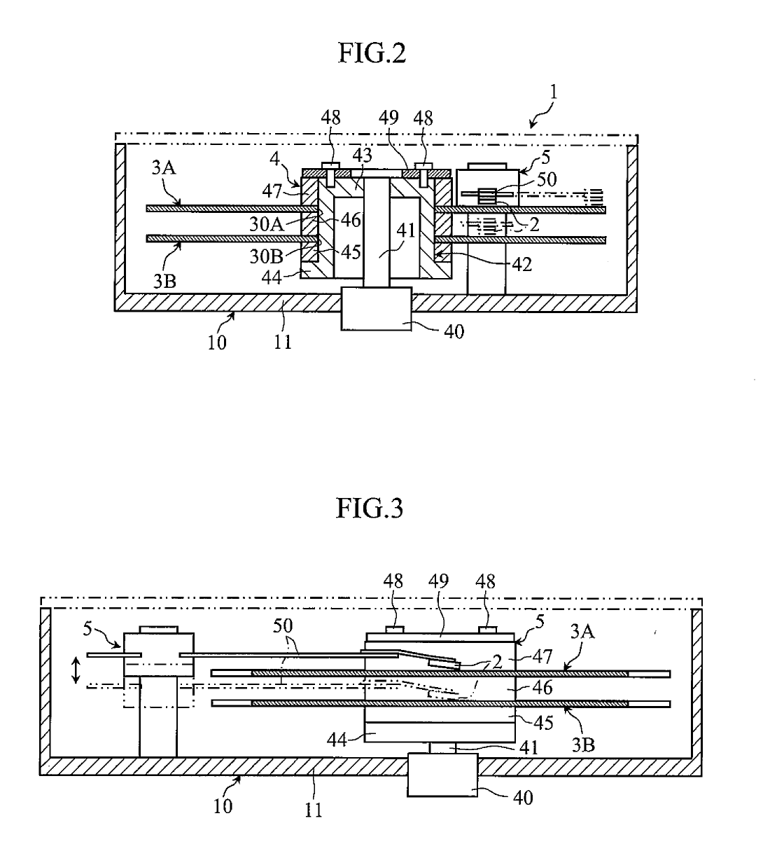

A hard disk drive 1 shown in FIGS. 1 to 3, which corresponds to an example of a recording medium driving device, includes a case 10. The case 10 stores a magnetic head 2, magnetic disks 3A, 3B and a rotary drive 4.

The magnetic head 2 accesses any of tracks to record and reproduce information. The magnetic head 2, which is supported via a suspension arm 50 to an actuator 5, moves in a noncontact state on the magnetic disks 3A, 3B. More specifically, the magnetic head 2 can be rotated in the radial direction of the magnetic disks 3A, 3B around the actuator 5, and can be reciprocated in a vertical direction. The magnetic head 2 is provided with an electromagnetic conversion element 20 and a slider 21.

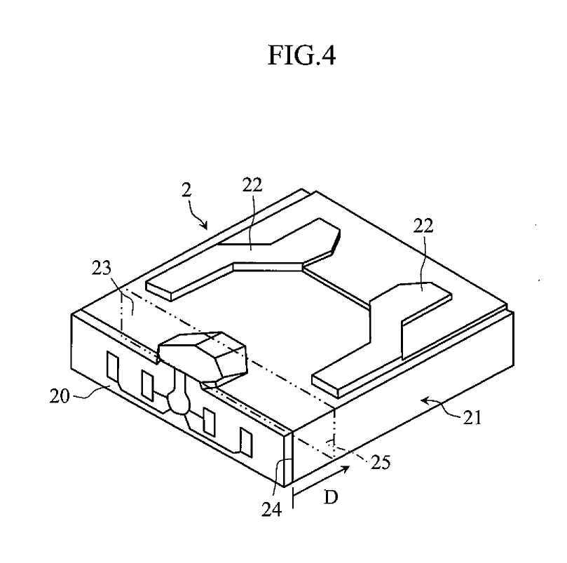

As shown in FIG. 4, the electromagnetic conversion element 20, which exhibits a magnetoresistance effect, is constituted as, for example, an MR (Magnetro Resistive) element (hereinafter, referred to as an “MR element”), a GMR (Giant Magnetro Resistive) element (hereinafter, referred to as a “GMR element”), or a TMR (Tunnel Magnetro Resistive) element (hereinafter, referred to as a “TMR element”).

The slider 21, which becomes a substrate of the magnetic head 2, is provided with a flying surface 22 and a recess part 23. The flying surface 22, which is a surface opposite to the magnetic disk 3, is formed as a mirror surface. The recess part 23 functions as a flow channel allowing air for flying the magnetic head to pass. The recess part 23, which is formed in a desired depth and shape by an ion milling method or a reactive ion etching method, has a surface having an arithmetic mean height Ra set to, for example, 20 nm or less (except for 0 nm). Since the formation of the recess part 23 with such surface roughness can enhance the smoothness of the recess part 23 and can control airflow appropriately, the formation can stabilize the flying characteristics of the magnetic head 2.

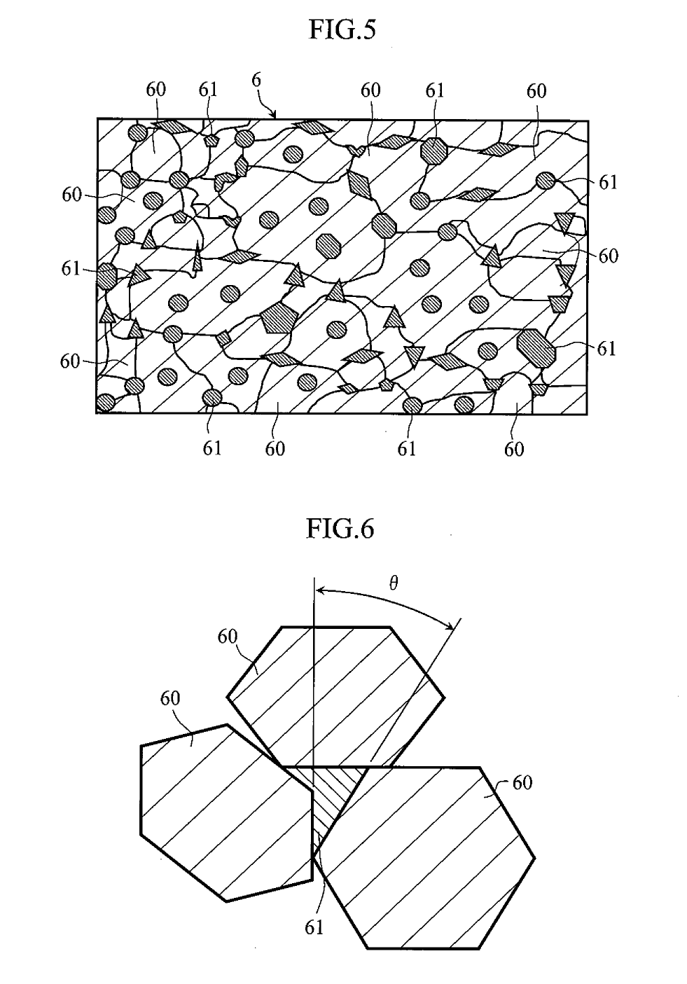

As shown in FIG. 5, the slider 21 includes a sintered body 6 containing 35% by mass to 60% by mass of alumina and 40% by mass to 65% by mass of a conductive compound. The ratio of the alumina and the conductive compound in the sintered body 6 (slider 21) can be obtained by obtaining the ratio of aluminum and tungsten according to ICP (Inductivity Coupled Plasma) emission spectrometry, carrying out mass conversion of the aluminum to an oxide thereof, and carrying out mass conversion of the tungsten to the carbide, nitride or carbonitride thereof according to the type of the conductive compound.

The sintered body 6 contains alumina crystal particles 60 and crystal particles 61 made of a conductive compound. The sintered body 6 has a maximum crystal particle size of 4 μm or less (except for 0 μm), preferably 1 μm or less. Since such a slider 21 can prevent the aggregation of the alumina crystal particles 60 and crystal particles 61 made of the conductive compound to uniformize the organization thereof, the slider 21 has reduced surface roughness to enhance the uniformity of the organization and has properly maintained conductivity.

For example, the alumina crystal particles 60 have a mean crystal particle size of 1 μm or less (except for 0 μm). By contrast, the crystal particles 61 made of the conductive compound, which are made of at least one compound selected from the carbide, nitride and carbonitride of tungsten, are preferably the tungsten carbide. Since the carbide of tungsten, which is used as the conductive compound, is more inexpensive than the nitride and carbonitride of tungsten, the carbide of tungsten is advantageous in terms of manufacturing costs. For example, the crystal particles 61 made of the conductive compound have a mean crystal particle size of 10 nm (0.01 μm) to 1 μm.

The maximum crystal particle size and the mean crystal particle size of the alumina crystal particles 60 and crystal particles 61 made of the conductive compound can be calculated by analyzing, for example, images photographed in a range of 5 μm×8 μm to 20 μm×32 μm using an image-analysis software (Image-Pro Plus). The images are obtained by photographing an end face 24 or a desired section of the slider 21 while properly selecting a magnification from 3250 to 13000 magnifications depending on the maximum crystal particle size or the mean crystal particle size using a scanning electron microscope (SEM).

It is preferable that the crystal particles 61 made of the conductive compound contain wedge-shaped particles. When the crystal particles 61 made of the conductive compound contain the wedge-shaped particles, the anchor effect of the crystal particles 61 made of the conductive compound to the alumina crystal particles 60 makes it difficult to drop both the alumina crystal particles 60 and the crystal particles 61 made of the conductive compound.

Herein, the wedge-shaped particles mean particles having at least one crossing angle θ of less than 90 degrees as shown in FIG. 6, the crossing angle θ formed by profile lines of the crystal particles 61 of the conductive compound when the end face 24 on the side of the electromagnetic conversion element 20 of the slider 21 or a mirror surface obtained by polishing an area of 1 mm or less from the end face 24 is observed by the scanning electron microscope (SEM) or the like. The minimum crossing angle θ is preferably located in the vertical direction to the flying surface 22 (see FIG. 4) of the magnetic head 2 since the highest anchor effect is obtained.

As shown in FIG. 4, in the slider 21, the distribution density of the crystal particles 61 (see FIGS. 5 and 6) made of the conductive compound is preferably 5×10⁵ particles/mm² or more in a surface 25 being parallel with the end face 24 and included in a region between the end face 24 and a surface positioned at a depth D of 1 mm from the end face 24 on the side of the electromagnetic conversion element 20. The distribution density of the crystal particles 61 of the conductive compound is more preferably 1×10⁶ particles/mm² or more.

In the slider 21, the distribution density of the crystal particles 61 of the conductive compound in the surface 25 included in the region between the end face 24 and the surface positioned at the depth D of 1 mm from the end face 24 can be set to 5×10⁵ particles/mm² or more to more appropriately maintain the conductivity. Furthermore, an electrified area in the end face 24 is decreased (dispersed), and thereby the generation of static electricity can be suppressed. When the distribution density is set to 5×10⁵ particles/mm², the heat dissipation of the crystal particles 61 of the conductive compound is good, and thereby the heat dissipation of the sintered body 6 can be also enhanced.

The distribution density is measured in the surface 25 being parallel with the end face 24 and included in the region between the end face 24 and the surface positioned at the depth D of 1 mm from the end face 24. This is because the heat dissipation in the end face 24 has an effect on the flying amount of the magnetic head 2 and the destruction of the recording of the magnetic disks 3A, 3B. As long as a measured surface for the distribution density is in the region between the end face 24 and the surface positioned at the depth D of 1 mm from the end face 24, the measured surface may be this end face 24 or a section. The measured range for the distribution density is preferably a range of 20 μm×20 μm in the measured surface This range can confirm the dispersion of the crystal particles 61 of the conductive compound sufficiently.

Herein, the distribution density of 5×10⁵ particles/mm² or more means a state where 200 or more particles 2 made of the conductive compound exist in a range of 20 μm×20 μm of, for example, the end face 24 or a desired section. The distribution density can be obtained from images of 7000 to 13000 magnifications photographed by the scanning electron microscope.

Furthermore, the slider 21 has a heat conductivity of, for example, 30 W/(m·k) or more and a flexural strength of, for example, 700 MPa or more. Since the heat conductivity of the slider 21 can be set to 30 W/(m·k) or more to promptly transfer the heat generated from the coil formed in the magnetic head 2, the destruction of recording saved in the magnetic disks 3A, 3B by heat can be suppressed. By contrast, since the flexural strength can be set to 700 MPa or more to prevent micro-cracks, the drop of the alumina and the conductive compound can be suppressed, and a magnetic head having good CSS (contact start stop) characteristics can be obtained.

Herein, the heat conductivity of the sintered body 6 forming the slider 21 can be measured based on JIS R 1611-1997, and the flexural strength thereof can be evaluated according to the 3 point bending strength based on JIS R 1601-1995.

The magnetic disks 3A, 3B shown in FIGS. 1 to 3, which correspond to an example of a recording medium, are provided with a magnetic recording layer (not shown). These magnetic disks 3A, 3B, which have through-holes 30A, 30B, respectively, are formed in a disk shape.

The rotary drive 4, which rotates the magnetic disk 3, is provided with a motor 40 and a rotating shaft 41. The motor 40, which applies a torque to the rotating shaft 41, is fixed to a bottom wall 11 of the case 10. The rotating shaft 41, which is rotated by the motor 40, supports the magnetic disks 3A, 3B. A hub 42 is fixed to this rotating shaft 41. The hub 42, which is rotated with the rotating shaft 41, has an inserting part 43 and a flange part 44. The magnetic disks 3A, 3B are laminated on the flange part 44 via spacers 45, 46, 47 with the inserting part 43 inserted into the through-holes 30A, 30B. Furthermore, the magnetic disks 3A, 3B are fixed to the hub 41 and therefore the rotating shaft 40 by fixing a clamp 49 to the spacer 47 using screws 48. In such a rotary drive 4, the hub 42 and therefore the magnetic disks 3A, 3B are rotated by rotating the rotating shaft 41 by the motor 40.

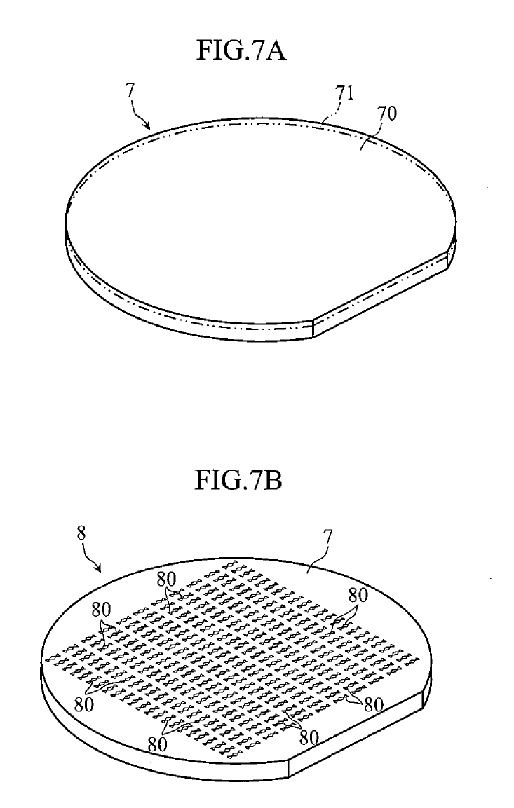

Next, a method for manufacturing the magnetic head 2 will be described with reference to FIGS. 7 to 12.

First, as shown in FIG. 7A, a disk-shaped magnetic head substrate 7 is formed. This magnetic head substrate 7 is produced by pressure sintering using granules obtained by mixing and granulating material powders.

There are used material powders containing 35% by mass to 60% by mass of an alumina powder and 40% by mass to 65% by mass of the conductive compound. 0.1% by mass to 0.6% by mass of at least one of Yb₂O₃, Y₂O₃ and MgO may be added as the material powders in order to accelerate sintering of the material powders to make the sintered body dense. The material powders are mixed using, for example, a ball mill, a vibrating mill, a colloid mill, an attritor or a high-speed mixer.

The alumina powder having a mean particle size of, for example, 0.3 μm to 0.7 μm is used. The alumina powder having a mean particle size of 0.3 μm to 0.7 μm is used since the sintered body is insufficiently densified to cause the strength poverty of the sintered body when the mean particle size of the alumina powder exceeds 0.7 μm, and the formability of the alumina powder tends to be reduced and the sintering thereof is difficult to control when the mean particle size is less than 0.3 μm. Therefore, the use of the alumina powder having a mean particle size of 0.3 μm to 0.7 μm accelerates the densification of the sintered body to easily provide strength required for the magnetic head substrate 7. Particularly, the use of the alumina powder having a mean particle size of 0.05 μm to 0.5 μm can set the mean particle size of the crystal particle of the alumina to 1.0 μm or less.

As the conductive compound, at least one of the carbide, nitride and carbonitride of tungsten (W) having a mean particle size of 10 nm to 800 nm is used. Of these, the carbide of tungsten which is more inexpensive than the nitride and carbonitride of tungsten is particularly preferably used. Then, the carbide of tungsten is advantageous in terms of manufacturing costs. The conductive compound having a mean particle size of 10 nm to 800 nm is used since the cohesive force of the powder of the particles made of the conductive compound is excessively strong to tend to form aggregates when the mean particle size is less than 10 nm, and the low temperature sintering property of the particles tends to be reduced when the mean particle size exceeds 800 nm. Therefore, the mean crystal particle size of the conductive compound can be set to 10 nm to 1 μm without forming the aggregates by using the powder of the particles made of the conductive compound and having a mean particle size of 10 nm to 800 nm to obtain the magnetic head substrate 7 having a good low temperature sintering property.

The mean particle size of the alumina powder and the conductive compound powder can be measured by a liquid phase settling method, a centrifugal settling optical transmitting method, a laser diffraction scattering method, a laser Doppler method or the like.

Forming auxiliary agents such as a binding agent and a dispersing agent are added into the mixture of the material powders and they are uniformly mixed. Then, the granulation to the granules can be carried out by using various granulators such as a rolling granulator, a spray drier and a compression granulator.

The obtained granules are molded in a desired shape using a molding means to produce a molded body, and the molded body is then subjected to pressure sintering in a reducing atmosphere. The molding is carried out by known means such as dry pressure molding and cold isostatic molding. The reducing atmosphere is attained by, for example, argon, helium, neon, nitrogen or vacuum. A pressing force is preferably set to 30 MPa or more. This pressing force can accelerate the densification of the sintered body to set strength required as the magnetic head substrate 7, for example, a flexural strength to 700 MPa or more. If the flexural strength of the magnetic head substrate 7 can be set to 700 MPa or more, the generation of the micro-cracks can be appropriately prevented. As a result, since the magnetic head substrate 7 can suppress the drop of the alumina particles or the conductive compound particles, the magnetic head having good CSS (contact start stop) characteristics can be obtained. The flexural strength can be evaluated according to the 3 point bending strength based on JIS R 1601-1995.

A sintering temperature is set to, for example, 1400° C. to 1700° C. It is because the material powder cannot be sufficiently sintered when the sintering temperature is less than 1400° C., and the particles made of the conductive compound tend to agglutinate when the sintering temperature exceeds 1700° C. and a function with which the conductive compound is originally provided cannot be sufficiently exhibited.

In addition, it is preferable that a masking material containing a carbonaceous material is arranged around the molded body, and the masking material and the molded body are subjected to pressure sintering. This can prevent the deterioration of the conductive compound particles to oxide particles and produce the magnetic head substrate 7 having excellent mechanical properties.

As shown in FIG. 4, the magnetic head substrate 7 thus formed includes the sintered body 6. The sintered body 6 contains 35% by mass to 60% by mass of alumina (crystal particles 60) and 40% by mass to 65% by mass of the conductive compound (crystal particles 61), and has a maximum crystal particle size of 4 μm or less (except for 0 μm). Such a sintered body (magnetic head substrate 7) can maintain sliding characteristics appropriately without reducing chipping resistance and the removal speed of electric charges in machining processing such as slicing processing since the sintered body contains 40% by mass or more of the conductive compound (crystal particles 61) and without deteriorating surface quality since the sintered body contains 65% by mass or less of the conductive compound (crystal particles 61). Herein, the total of the alumina and the conductive compound particles in the sintered body 6 (magnetic head substrate 7) is shown to be 100% by mass. However, the sintered body 6 may contain impurities of 0.5% by mass or less.

The ratio of alumina and conductive compound particles in the sintered body 6 (magnetic head substrate 7) can be obtained based on the ratio of the alumina and tungsten according to ICP (Inductivity Coupled Plasma) emission spectrometry as in the case of the slider 21.

Alternatively, in the sintered body 6 (magnetic head substrate 7), the particle sizes and sintering conditions (sintering temperature and sintering pressure) of the material powders are properly adjusted. Thereby, the mean crystal particle size of the crystal particles 61 made of the conductive compound is set to, for example, 10 nm (0.01 μm) to 1 μm. The distribution density of the crystal particles in a surface 71 (see FIG. 7) being parallel with a principal surface 70 on which an electromagnetic converter element is formed and included in a region between the principal surface 70 and a surface positioned at a depth of 1 mm from the principal surface 70 is set to 5×10⁵ particles/mm² or more.

The mean crystal particle size of the conductive compound in the magnetic head substrate 7 can be set to 10 nm (0.01 μm) to 1 μm to uniformize the resistance value of the overall magnetic head substrate 7 and set the volume resistance thereof to 1 Ω·cm or less.

In addition, the distribution density of the crystal particles 61 made of the conductive compound can be set to 5×10⁵ particles/mm² or more to make the excellent machinability of the magnetic head substrate 7 good while maintaining the conductivity thereof and enhance the heat dissipation thereof. The definition and measuring method of the distribution density of the crystal particles 61 made of the conductive compound are the same as those of the slider 21.

Furthermore, the sintering temperature can be set to 1500° C. or more to agglutinate the crystal particles 61 made of the conductive compound to some extent to partially form the crystal particles 61 made of the conductive compound in the wedge shape. Herein, the definition of the wedge shape is the same as that of the case where the slider 21 is described with reference to FIG. 4. When the magnetic head substrate 7 contains the wedge-shaped particles as the crystal particles 61 made of the conductive compound, the anchor effect of the crystal particles 61 made of the conductive compound to the alumina crystal particles 60 is difficult to drop the alumina crystal particles 60 and the crystal particles 61 made of the conductive compound. Therefore, since the magnetic head substrate 7 has excellent machinability, and has a machining processed surface having desired surface roughness, the magnetic head 2 having stabilized flying characteristics can be provided.

In addition, the composition of the material powder can be properly selected to set the heat conductivity of the sintered body (magnetic head substrate 7) to, for example, 30 W/(m·k) or more. In that case, the slider 21 (magnetic head 2) obtained from the magnetic head substrate 7 has excellent heat conductivity. Therefore, since the heat generated from the coil (not shown) of the electromagnetic conversion element 20 in the magnetic head 2 is promptly transferred, the magnetic head 2 which can suppress the destruction of the recording saved in the recording medium by heat in the magnetic head substrate 7 can be provided. The heat conductivity can be measured based on JIS R 1611-1997.

Next, as shown in FIG. 7B, a base film made of amorphous alumina is previously formed on the magnetic head substrate 7 by a bias sputter method, and a plurality of electromagnetic converter elements 80 are then collectively fabricated on the magnetic head substrate 7 to form a set substrate 8.

The plurality of electromagnetic converter elements 80 are fabricated on the magnetic head substrate 7 by forming, for example, a gap film, a protective film, an upper and lower magnetic pole films, a coil film or an insulating film using a semiconductor integrating technique. The gap film and the protective film are formed as an alumina sputter film by, for example, the bias sputter method. The upper and lower magnetic pole films and the coil film are formed by, for example, a plating method. The upper and lower magnetic pole films are made of, for example, a Ni—Fe alloy, and the coil film is made of, for example, copper. The insulating film, which maintains insulating properties between the magnetic pole film and the coil and between the coils, is formed by, for example, a photolithographic method using a thermosetting resin having insulating properties.

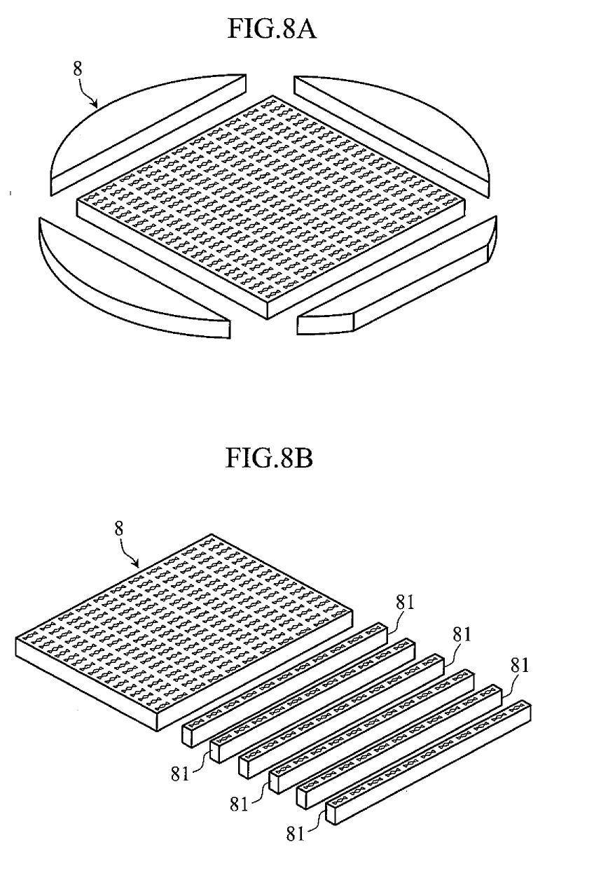

Next, as shown in FIGS. 8A, 8B, the set substrate 8 is cut to obtain strip pieces 81. This step includes a first cutting process of squarely cutting the set substrate 8 as shown in FIG. 8A and a second cutting process of cutting the set substrate 8 into the strip pieces 81 in a line in which the electromagnetic converter elements 80 are located as one unit as shown in FIG. 83. The first and second cutting processes are carried out using, for example, a diamond cutter.

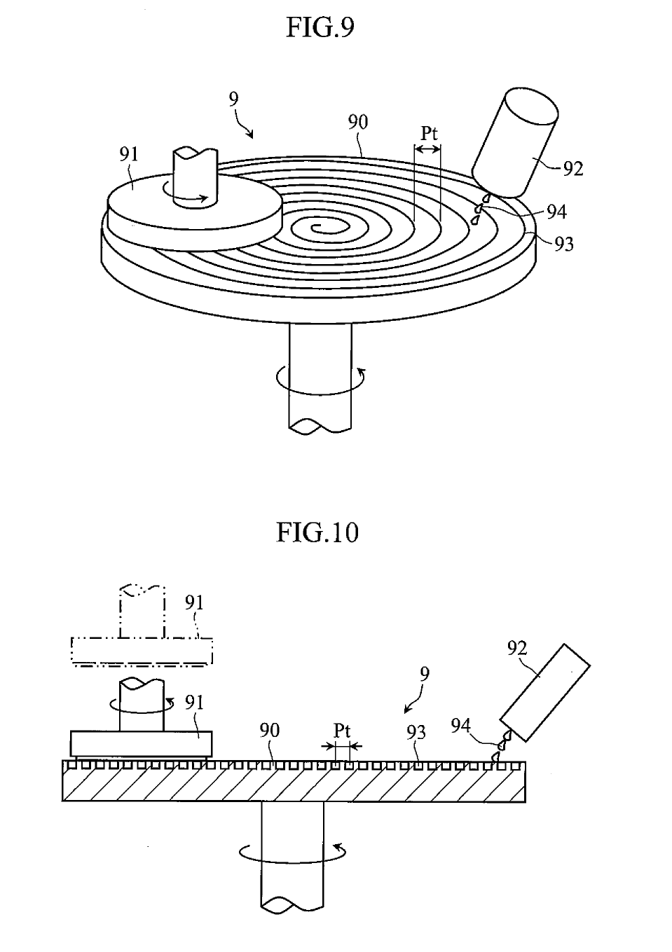

Next, a surface which should become the flying surface 22 (see FIG. 4) of the slider 21 in the strip pieces 81 is polished. This polishing is carried out using a lap device 9 shown in, for example, FIGS. 9 and 10. The lap device 9 is provided with a lapping machine 90, a lapping jig 91 and a container 92.

The lapping machine 90, which is rotated by a driving part (not shown), is made of, for example, tin and has a flatness of 10 μm or less and a Vickers hardness (Hᵥ) of 78 MPa. This lapping machine 90 has a spiral groove 93. The groove 93 has a rectangle-shaped section and a pitch Pt set to, for example, 0.1 to 0.5 mm.

The lapping jig 91, which holds the strip pieces 81, is formed in a disk shape. This lapping jig 91, which can be reciprocally moved in a vertical direction by an actuator (not shown), presses the held strip pieces 81 against the lapping machine 90 under a predetermined pressure.

The container 92 holds a polishing solution 94 supplied to the lapping machine 90. As the polishing solution 94, a slurry polishing solution, which contains abrasive particles with a concentration of, for example, 0.1 to 1.0 g/L and has a pH of 7.5 to 8.5, can be used. As the abrasive particles, diamond abrasive particles having a mean particle size of, for example, 0.05 to 0.15 μm can be used.

When the strip pieces 81 are polished using such a lap device 9, the strip pieces 81 are polished by pressing the lapping jig 91 holding the strip pieces 81 against the lapping machine 90 with the polishing solution 94 from the container 92 discharged to the lapping machine 90 while the lapping machine 90 is rotated at a predetermined circumferential speed. The discharge speed of the polishing solution 94 from the container 92 is set to, for example, 0.3 mL/60 sec. The rotating speed of the lapping machine 90 is set to, for example, 0.5 to 1.0 m/sec. A pressure for pressing the strip pieces 81 (lapping jig 91) against the lapping machine 90 is set to, for example, 50 to 100 MPa. Thus, the surface which should become the flying surface 22 (see FIG. 4) of the slider 21 in the strip pieces 81 is polished to form a polished surface 82 as a mirror surface having an arithmetic mean roughness Ra of 0.2 to 0.4 nm.

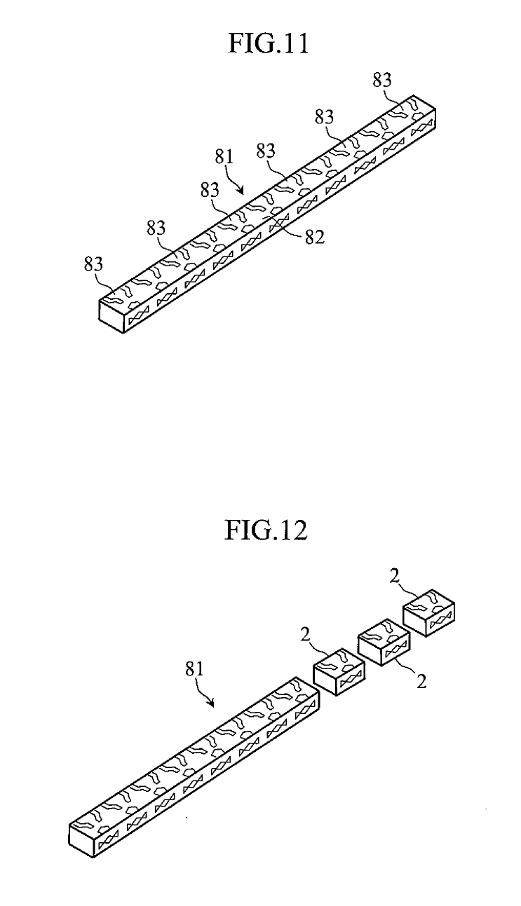

Next, as shown in FIG. 11, recess parts 83 are formed in the polished surface 82 of the strip piece 81. The recess parts 83 function as a flow channel (recess part 23) (see FIG. 4) allowing air for flying the magnetic head 2 to pass. The mirror surface remaining without being removed in the polished surface 82 is formed as the flying surface 22 (see FIG. 4) opposite to the magnetic recording medium in the magnetic head 2. The recess parts 83 are formed in a desired depth, shape and surface roughness by the ion milling method or the reactive ion etching method. The arithmetic mean roughness Ra in the surface of the recess part 83 is set to, for example, 20 nm or less (except for 0 nm). Since the recess parts 83 having such a surface roughness can enhance the smoothness of the recess part 23 (see FIG. 4) in the magnetic head 2 to control airflow appropriately, the recess parts 83 can stabilize the flying characteristics of the magnetic head 2.

Finally, as shown in FIG. 12, the chip-shaped magnetic head 2 shown in FIG. 4 can be obtained by cutting the strip piece 81 in which the recess parts 83 are formed.

### EXAMPLES

Hereinafter, examples of the present invention will be described. However, the present invention is not limited to these examples.

### Example 1

This example used a plurality of test specimens having a different composition and an organization state and studied the influence of the composition and the organization state on mechanical characteristics.

### (Preparation of Test Specimens)

A molded body was formed using a slurry containing material powders blended to a desired composition. This molded body was then subjected to pressure sintering to form a magnetic head substrate, and this magnetic head substrate was cut to produce test specimens.

Alumina, a conductive compound and Yb₂O₃ were used as the material powders, and a dispersing agent was added into these material powders.

The mean particle size and the content of alumina and the conductive compound in the material powders were selected to adjust the mean crystal particle size and the content of alumina and the conductive compound in sintered bodies (test specimens) as shown in the following Table 1. The content of Yb₂O₃ in the material powders was set to 0.2% by mass.

The slurry was put into a spray dryer to form granules, and 10% of ion exchanged water was then sprayed to the granules to form a binder. The binder was subjected to dry pressure molding to form the molded body.

The molded body, which was arranged in a mold (diameter: 127 mm, depth: 2 mm), was subjected to pressure sintering in an argon atmosphere. The following Table 1 shows the sintering temperatures.

The magnetic head substrate was cut to form plate test specimens in 10 mm×10 mm×2 mm and in 20 mm×50 mm×1.2 mm.

### (Observation of Organization State)

The organization states of the test specimens were observed as the mean crystal particle size of each of the alumina and the conductive compound, and the maximum crystal particle size and mean crystal particle size of the test specimens. The maximum crystal particle size and the mean crystal particle size were calculated by analyzing, for example, images photographed in a range of 5 μm×8 μm to 20 μm×32 μm using an image-analysis software (Image-Pro Plus). The images were obtained by taking photographs while properly selecting a magnification from 3250 to 13000 magnifications depending on the maximum crystal particle size or the mean crystal particle size using a scanning electron microscope (SEM). Table 1 shows calculated results of the mean crystal particle size of each of the alumina and the conductive compound, and the maximum crystal particle size and the mean crystal particle size of the test specimens.

### (Compositions of Test Specimens)

The compositions of the test specimens were calculated as the weight ratio of the alumina and the conductive compound. First, the ratio of aluminum and tungsten was obtained using an ICP (Inductivity Coupled Plasma) emission spectrometer (SPS1200VR, manufactured by Seiko Instruments Inc.). Then, the aluminum was converted to the weight of the oxide thereof, and the tungsten was converted to the weight of the carbide, nitride or carbonitride thereof depending on the types of the conductive compounds to calculate the ratios (% by weight) thereof. Table 1 shows the calculated results of the weight ratios.

### (Evaluation of Mechanical Characteristics)

Mechanical characteristics were evaluated as a wrapping rate, the surface roughness of a recess part, and a Vickers hardness.

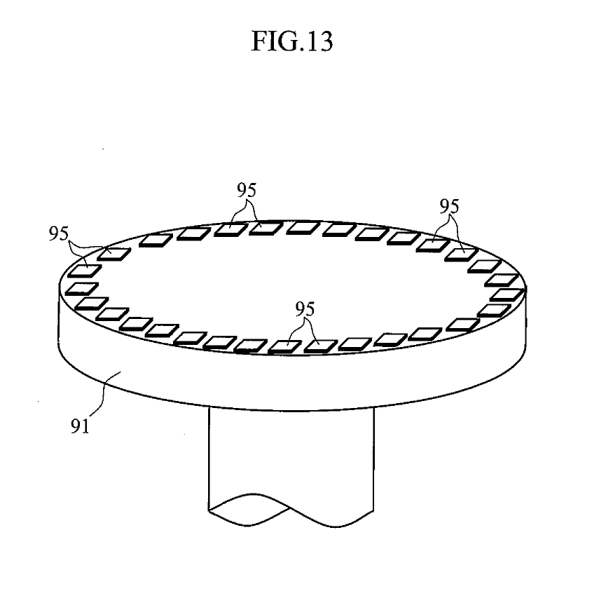

The wrapping rate was evaluated as a polishing amount per unit time using the lap device 9 (9″ type manufactured by Lap Master SFT Co) shown in FIGS. 9 and 10. As the polishing solution 94, a slurry polishing solution which was obtained by dispersing diamond abrasive particles having a mean particle size of 0.1 μm with a concentration of 0.5 g/L and had a pH of 8.1 was used. As the lapping machine 90, a lapping machine was used, which had a flatness of 10 μm or less, a Vickers hardness (H) of 78 MPa and a groove 95 having a pitch Pt of 0.3 mm and was made of tin. The rotating speed of the lapping machine 90 was set to 0.65 m/second as a circumferential speed. As shown in FIG. 13, 30 test specimens 95 of 10 mm×10 mm times 2 mm were circumferentially arranged with equal intervals on the lapping jig 91. The supplying speed of the polishing solution 94 to the lapping machine 90 was set to 0.3 mL/60 sec. The pressing pressure of the test specimen 95 to the lapping machine 90 was set to 0.07 MPa.

The thickness (tₐ) of the test specimen 95 before being lap-processed and the thickness (t_{b}) of the test specimen 95 after being lap-processed were respectively measured using a dial gage, and the difference (tₐ−t_{b}) was divided by the time required for lap-processing to obtain the wrapping rate.

The surface roughness of the recess parts was measured as an arithmetic mean height (Ra) based on JIS B 0601-2001 using an atomic force microscope. The evaluation length was set to 10 μm. The recess parts were formed using an ion milling device (“AP-MIED type” manufactured by JEOL Co., Ltd.). The test specimens of 20 mm×50 mm×1.2 mm were subjected to ion milling in an accelerating voltage of 3 kV/30 mA, a collision angle of 35 degrees and an ion milling depth of 0.2 μm using Ar⁺ ions.

The Vickers hardness was measured based on JIS R 1610-2003 except that a test force was set to 196 N.

Table 1 shows the measured results of the wrapping rate, the surface roughness of the recess parts and the Vickers hardness.

TABLE 1

| | | | Conductive compound | | | Sintered body | | | | | | |
|---|---|---|---|---|---|---|---|---|---|---|---|---|
| | Alumina | | | | Mean | Maximum | Mean | | | | Arithmetic mean | |
| | | Mean | | Content | crystal | crystal | crystal | | Firing | | height Ra | Vickers |
| | Content | crystal | | (% | particle | particle | particle | | tempera- | Wrapping | after ion | hardness |
| Sample | (% by | particle | | by | size | size | size | Sintering | ture | rate | milling method | Hv |
| No. | mass) | size (μm) | Types | mass) | (μm) | (μm) | (μm) | method | (° C.) | (μm/min) | (nm) | (GPa) |
| * 1 | 55 | 0.1 | WC | 45 | 0.02 | — | — | — | — | — | — | — |
| 2 | 55 | 0.3 | WC | 45 | 0.02 | 2.5 | 0.42 | Pressure | 1500 | 0.11 | 15 | 20.5 |
| | | | | | | | | sintering | | | | |
| * 3 | 55 | 0.5 | WC | 45 | 0.005 | 10 | 0.7 | Pressure | 1500 | 0.121 | 24 | 20.2 |
| | | | | | | | | sintering | | | | |
| 4 | 55 | 0.5 | WC | 45 | 0.01 | 2 | 0.35 | Pressure | 1500 | 0.113 | 14 | 20.6 |
| | | | | | | | | sintering | | | | |
| 5 | 55 | 0.5 | WC | 45 | 0.4 | 2.2 | 0.6 | Pressure | 1500 | 0.095 | 16 | 20.2 |
| | | | | | | | | sintering | | | | |
| 6 | 55 | 0.5 | WC | 45 | 1.2 | 3.6 | 0.85 | Pressure | 1500 | 0.107 | 20 | 20.3 |
| | | | | | | | | sintering | | | | |
| * 7 | 55 | 0.5 | WC | 45 | 0.4 | — | — | Pressure | 1350 | — | — | — |
| | | | | | | | | sintering | | | | |
| 8 | 55 | 0.5 | WC | 45 | 0.4 | 3 | 0.8 | Pressure | 1400 | 0.112 | 17 | 19.7 |
| | | | | | | | | sintering | | | | |
| * 9 | 55 | 0.5 | WC | 35 | 0.4 | 3 | 0.9 | Pressure | 1500 | 0.132 | 26 | 19.4 |
| | | | | | | | | sintering | | | | |
| 10 | 60 | 0.5 | WC | 40 | 0.4 | 3.5 | 0.8 | Pressure | 1500 | 0.11 | 18 | 19.6 |
| | | | | | | | | sintering | | | | |
| 11 | 55 | 0.5 | WC | 45 | 0.4 | 2.3 | 0.6 | Pressure | 1500 | 0.098 | 18 | 20.3 |
| | | | | | | | | sintering | | | | |
| 12 | 35 | 0.5 | WC | 65 | 0.4 | 3 | 0.5 | Pressure | 1500 | 0.13 | 18 | 20.4 |
| | | | | | | | | sintering | | | | |
| * 13 | 30 | 0.5 | WC | 70 | 0.4 | 3.5 | 0.4 | Pressure | 1500 | 0.062 | 26 | 20.5 |
| | | | | | | | | sintering | | | | |
| 14 | 55 | 0.5 | WC | 45 | 0.4 | 1.4 | 0.5 | Pressure | 1700 | 0.095 | 17 | 20.4 |
| | | | | | | | | sintering | | | | |
| 15 | 55 | 0.5 | WC | 45 | 0.4 | 3.6 | 0.6 | Pressure | 1750 | 0.102 | 16 | 20.1 |
| | | | | | | | | sintering | | | | |
| 16 | 55 | 1 | WC | 45 | 0.4 | 3.6 | 0.95 | Pressure | 1800 | 0.132 | 19 | 19.6 |
| | | | | | | | | sintering | | | | |
| 17 | 55 | 1.2 | WC | 45 | 0.4 | 3.6 | 0.98 | Pressure | 1830 | 0.124 | 21 | 19.8 |
| | | | | | | | | sintering | | | | |
| 18 | 55 | 0.5 | WC | 45 | 0.4 | 3.6 | 0.85 | Pressure | 1770 | 0.113 | 18 | 20.2 |
| | | | | | | | | sintering | | | | |
| 19 | 55 | 0.5 | WC | 45 | 0.4 | 3.8 | 1 | Pressure | 1850 | 0.127 | 20 | 19.7 |
| | | | | | | | | sintering | | | | |
| * 20 | 55 | 0.5 | WC | 45 | 0.4 | 13 | 1.2 | Pressure | 1800 | 0.09 | 36 | 19.3 |
| | | | | | | | | sintering | | | | |
| * 21 | 55 | 0.5 | WC | 45 | 0.4 | 15 | 1.5 | Pressure | 1500 | 0.08 | — | 18.4 |
| | | | | | | | | sintering | | | | |
| 22 | 55 | 0.5 | WC | 45 | 0.8 | 3.8 | 0.9 | Pressure | 1500 | 0.102 | 20 | 18.4 |
| | | | | | | | | sintering | | | | |
| * 23 | 55 | 0.5 | WC | 45 | 1 | 5.7 | 1.4 | Pressure | 1500 | 0.11 | 24 | 19.2 |
| | | | | | | | | sintering | | | | |
| 24 | 55 | 0.7 | WC | 45 | 0.2 | 3.8 | 1.1 | Pressure | 1500 | 0.093 | 22 | 19.3 |
| | | | | | | | | sintering | | | | |
| * 25 | 55 | 1 | WC | 45 | 2 | 18 | 2.3 | Pressure | 1500 | 0.067 | 28 | 18.7 |
| | | | | | | | | sintering | | | | |
| * 26 | 55 | 0.5 | WN | 35 | 0.4 | 3.7 | 0.9 | Pressure | 1500 | 0.075 | 21 | 19.1 |
| | | | | | | | | sintering | | | | |
| 27 | 50 | 0.5 | WN | 40 | 0.4 | 3.6 | 0.8 | Pressure | 1500 | 0.082 | 17 | 19.2 |
| | | | | | | | | sintering | | | | |
| 28 | 55 | 0.5 | WN | 45 | 0.4 | 3.7 | 0.7 | Pressure | 1500 | 0.098 | 18 | 19.5 |
| | | | | | | | | sintering | | | | |
| 29 | 35 | 0.5 | WN | 65 | 0.4 | 3.6 | 0.6 | Pressure | 1500 | 0.11 | 20 | 19.7 |
| | | | | | | | | sintering | | | | |
| * 30 | 30 | 0.5 | WN | 70 | 0.4 | 3.8 | 0.5 | Pressure | 1500 | 0.045 | 25 | 19.9 |
| | | | | | | | | sintering | | | | |
| * 31 | 65 | 0.5 | WCN | 35 | 0.4 | 3.4 | 0.9 | Pressure | 1500 | 0.078 | 24 | 19.2 |
| | | | | | | | | sintering | | | | |
| 32 | 60 | 0.5 | WCN | 40 | 0.4 | 3.5 | 0.8 | Pressure | 1500 | 0.089 | 18 | 19.4 |
| | | | | | | | | sintering | | | | |
| 33 | 55 | 0.5 | WCN | 45 | 0.4 | 3.6 | 0.7 | Pressure | 1500 | 0.092 | 18 | 19.4 |
| | | | | | | | | sintering | | | | |
| 34 | 35 | 0.5 | WCN | 65 | 0.4 | 4 | 0.7 | Pressure | 1500 | 0.064 | 20 | 20.1 |
| | | | | | | | | sintering | | | | |
| * 35 | 30 | 0.5 | WCN | 70 | 0.4 | 3.8 | 0.6 | Pressure | 1500 | 0.052 | 25 | 20.2 |
| | | | | | | | | sintering | | | | |
| 36 | 55 | 0.5 | WC | 45 | 0.01 | 3.5 | 0.6 | Pressure | 1500 | 0.113 | 18 | 19.4 |
| | | | | | | | | sintering | | | | |
| * 37 | 55 | 0.5 | WC | 45 | 0.005 | 5 | 0.5 | Pressure | 1500 | 0.121 | 25 | 18.8 |
| | | | | | | | | sintering | | | | |

Samples to which * is attached are out of claims of the present invention.

As shown in Table 1, samples (No. 2, 4 to 6, 8, 10 to 12, 14 to 19, 22, 24, 27 to 29, 32 to 34, and 36) of the present invention included a sintered body (test specimen) containing 35% by mass to 60% by mass of the alumina and 40% by mass to 65% by mass of the conductive compound and having a maximum crystal particle size of 4 μm or less. The samples had a wrapping rate of 0.064 μm/min or more and the Vickers hardness of 19.2 GPa or more. The arithmetic mean height Ra of the recess parts after the ion milling method was 22 nm or less. The organizations of the alumina and the conductive compound after the ion milling method had high dispersibility. Therefore, a surface having very high precision could be obtained.

The samples in which a mean crystal particle size of the sintered bodies (test specimens) except No. 24 of the samples of the present invention was set to 1 μm or less could obtain a surface having higher precision since the arithmetic mean height Ra of the recess parts after the ion milling method was 21 nm or less. In addition, samples in which the mean crystal particle size of the alumina of the sintered bodies (test specimens) except No. 17 was set to 1 μm or less, and samples in which the mean crystal particle size of the conductive compound particles except No. 6 was set to 10 nm (0.01 μm) to 1 μm could obtain a surface having higher precise since the arithmetic mean height Ra after the ion milling method was 20 nm or less.

It was clear that the resistance between samples (No. 2, 4 to 6, 8, 10 to 12, 14 to 19, 22, 24, and 36) using the carbide (WC) of tungsten as the conductive compound of the samples of the present invention and the diamond abrasive particles increased as compared with the other conductive compounds (WN and WCN), and the wrapping rate became a higher value of 0.093 μm/min or more.

On the other hand, since the mean particle size of the alumina powder of No. 1 was 0.3 μm or less, the dispersibility of the alumina powder itself was reduced. In addition, the elastic recovery of the molded body was also increased. As a result, the sample No. 1 could not be sintered well. Since the pressure sintering temperature of No. 7 was less than 1400° C. and No. 21 used pressureless sintering, both Nos. 7 and 21 could not be sufficiently sintered, and not all the evaluations could be carried out.

In addition, samples (No. 3, 20, 21, 23, 25, and 37) in which the maximum particle size of the sintered body exceeded 4 μm had a very high arithmetic mean height Ra after the ion milling method since the arithmetic mean height Ra was 24 nm to 36 nm.

Similarly, it was clear that many of samples (No. 9, 13, 26, 30, 31, and 35) which did not contain 35% by mass to 60% by mass of the alumina and 40% by mass to 65% by mass of the conductive compound had a low wrapping rate of 0.045 μm/min and an arithmetic mean height Ra after the ion milling method of about 25 nm to reduce the processability.

### Example 2

In this example, the influence of the distribution density of the conductive compound in the test specimens on conductivity or mechanical characteristics was studied.

### (Preparation of Test Specimens)

Test specimens were produced in the same manner as in Example 1. The mean crystal particle size and the content of alumina and the conductive compound particles in the sintered body (test specimen) were adjusted as shown in Table 2, and the firing temperature was adjusted to adjust the distribution density of the conductive compound particles of the test specimens. As the test specimens, the sintered body was cut to produce a plate test specimen of 10 mm×10 mm×2 mm and a long test specimen of 20 mm×50 mm×3.5 mm.

### (Measurement of Distribution Density)

Test specimens were subjected to lap-processing in the same conditions as those of Example 1, and the number of the conductive compound particles in a range of 20 μm×20 μm of a lap-processed surface was counted using the scanning electron microscope to confirm the distribution density of the test specimens. As the magnification in the scanning electron microscope, an optimal magnification was selected from a range of 7000 to 13000 magnifications. In the observation of the scanning electron microscope, the shape of the conductive compound particles was simultaneously confirmed.

### (Mechanical Characteristics)

Mechanical characteristics were evaluated as a volume resistance, a wrapping rate and a maximum chipping amount,

The volume resistance was measured based on JIS C 2141-1992.

The wrapping rate was measured in the same manner as in Example 1.

The maximum chipping amount was measured from a groove surface when forming a groove in the test specimens using a slicer (“SPG25N-13K type” manufactured by FUJIKOSHI Corporation). As the test specimen, 10 long test specimens of 20 mm×50 mm×3.5 mm were prepared for each sample. As a diamond blade in the slicer, SD1200EL-1 H/Size (a diamond blade having a size of 99 mm in width×40 mm in height×0.07 mm in thickness) was used. The groove was formed in the following conditions: a sending speed of the diamond blade of 220 mm/min; a rotation number of 10000 rpm; a processing depth of 3.5 mm; a processing pitch of 2 mm; and a processing length of 50 mm. The surface of the groove was photographed with 1000 magnifications using a metallurgical microscope, and an image in a range of 60 μm×80 μm was analyzed to calculate the maximum chipping amount.

Table 2 shows the measured results of the volume resistance, the wrapping rate and the maximum chipping amount.

TABLE 2

| | Alumina | | Conductive compound | | | | Sintered body | | | | | | | |
|---|---|---|---|---|---|---|---|---|---|---|---|---|---|---|
| | | Mean | | | Main | Presence | Maximum | Mean | | | | | | Maxi- |
| | Con- | crystal | | Con- | crystal | or absence | crystal | crystal | | | Distri- | Volume | Wrap- | mum |
| | tent | parti- | | tent | parti- | of | parti- | parti- | | Firing | bution | resis- | ping | chip- |
| Sam- | (% | cle | | (% | cle | wedge- | cle | cle | | tempera- | density | tance | rate | ping |
| ple | by | size | | by | size | shaped | size | size | Sintering | ture | (particle/ | (Ω · | (μm/ | amount |
| No. | mass) | (μm) | Types | mass) | (μm) | crystal | (μm) | (μm) | method | (° C.) | mm²) | cm) | min) | (μm) |
| 38 | 35 | 0.5 | WC | 65 | 1.4 | Present | 4 | 1.8 | Pressure | 1800 | 30 | 5.5 × 10¹³ | 0.038 | 16 |
| | | | | | | | | | sintering | | | | | |
| 39 | 40 | 0.5 | WC | 60 | 0.8 | Present | 3.9 | 1.4 | Pressure | 1750 | 2.1 × 10⁵ | 9.0 × 10⁻² | 0.062 | 10 |
| | | | | | | | | | sintering | | | | | |
| 40 | 55 | 0.5 | WC | 45 | 1 | Present | 3.8 | 1.5 | Pressure | 1850 | 4.2 × 10⁵ | 5.0 × 10⁻² | 0.07 | 11 |
| | | | | | | | | | sintering | | | | | |
| 41 | 40 | 0.5 | WC | 60 | 0.4 | Present | 3.6 | 0.7 | Pressure | 1700 | 5.0 × 10⁵ | 1.9 × 10⁻³ | 0.086 | 5 |
| | | | | | | | | | sintering | | | | | |
| 42 | 45 | 0.5 | WC | 55 | 0.4 | Present | 3.8 | 0.6 | Pressure | 1700 | 5.3 × 10⁵ | 2.2 × 10⁻³ | 0.089 | 5 |
| | | | | | | | | | sintering | | | | | |
| 43 | 55 | 0.5 | WC | 45 | 0.4 | Present | 3.2 | 0.6 | Pressure | 1650 | 5.6 × 10⁵ | 2.7 × 10⁻³ | 0.98 | 5 |
| | | | | | | | | | sintering | | | | | |
| 44 | 40 | 0.5 | WC | 60 | 0.4 | Present | 2.6 | 0.5 | Pressure | 1600 | 6.8 × 10⁵ | 3.0 × 10⁻³ | 0.078 | 4 |
| | | | | | | | | | sintering | | | | | |
| 45 | 50 | 0.3 | WC | 50 | 0.4 | Present | 3.5 | 0.54 | Pressure | 1500 | 1.7 × 10⁶ | 2.5 × 10⁻³ | 0.09 | 4 |
| | | | | | | | | | sintering | | | | | |
| 46 | 55 | 0.3 | WC | 45 | 0.3 | Absent | 2.6 | 0.48 | Pressure | 1400 | 2.0 × 10⁵ | 1.1 × 10⁻² | 0.083 | 11 |
| | | | | | | | | | sintering | | | | | |
| 47 | 50 | 0.5 | WC | 50 | 0.4 | Absent | 2.2 | 0.4 | Pressure | 1400 | 3.7 × 10⁶ | 1.8 × 10⁻² | 0.086 | 10 |
| | | | | | | | | | sintering | | | | | |

As shown in Table 2, samples (Nos. 41 to 47) in which the distribution density of the conductive compound particles is 5×10⁵ particles/mm² or more in samples of the present invention had a low volume resistance of 3×10⁻³ Ω·cm or less and a small maximum chipping amount of 11 μm or less.

Particularly, the samples (Nos. 41 to 45) containing the wedge-shaped particles as the conductive compound particles of these samples could further reduce the maximum chipping amount to 6 μm or less.

1. A magnetic head substrate comprising a sintered body containing 35% by mass to 60% by mass of alumina and 40% by mass to 65% by mass of a conductive compound,
the conductive compound being at least one selected from carbide, nitride and carbonitride of tungsten, and
the sintered body having a maximum crystal particle size of 4 μm or less (except for 0 μm).

2. The magnetic head substrate according to claim 1, wherein the sintered body has a mean crystal particle size of 1 μm or less (except for 0 μm).

3. The magnetic head substrate according to claim 1, wherein the alumina has a mean crystal particle size of 1 μm or less (except for 0 μm).

4. The magnetic head substrate according to claim 1, wherein the conductive compound is the carbide of tungsten.

5. The magnetic head substrate according to claim 1, wherein the conductive compound has a mean crystal particle size of 10 nm (0.01 μm) to 1 μm.

6. The magnetic head substrate according to claim 1, wherein a distribution density of crystal particles made of the conductive compound is 5×10⁵ particles/mm² or more in a surface being parallel with a principal surface on which an electromagnetic converter element is formed and included in a region between the principal surface and a surface positioned at a depth of 1 mm from the principal surface.

7. The magnetic head substrate according to claim 1, wherein crystal particles made of the conductive compound contain wedge-shaped particles.

8. The magnetic head substrate according to claim 1, wherein the sintered body has a heat conductivity of 30 W/(m·k) or more.

9. The magnetic head substrate according to claim 1, wherein the sintered body has a flexural strength of 700 MPa or more.

10. A magnetic head comprising a slider and an electromagnetic converter element,
the slider comprising a sintered body containing 35% by mass to 60% by mass of alumina and 40% by mass to 65% by mass of a conductive compound,
the conductive compound being at least one selected from carbide, nitride and carbonitride of tungsten, and
the sintered body having a maximum crystal particle size of 4 μm or less (except for 0 μm).

11. The magnetic head according to claim 10, wherein the sintered body has a mean crystal particle size of 1 μm or less (except for 0 μm).

12. The magnetic head according to claim 10, wherein the alumina has a mean crystal particle size of 1 μm or less (except for 0 μm).

13. The magnetic head according to claim 10, wherein the conductive compound is the carbide of tungsten.

14. The magnetic head according to claim 10, wherein the conductive compound has a mean crystal particle size of 10 nm (0.01 μm) to 1 μm.

15. The magnetic head according to claim 10, wherein a distribution density of crystal particles made of the conductive compound is 5×10⁵ particles/mm² or more in a surface being parallel with an end face of the slider on which an electromagnetic converter element is formed and included in a region between the end face and a surface positioned at a depth of 1 mm from the end face.

16. The magnetic head according to claim 10, wherein crystal particles made of the conductive compound contain wedge-shaped particles.

17. The magnetic head according to claim 10, wherein the sintered body has a heat conductivity of 30 W/(m·k) or more.

18. The magnetic head according to claim 10, wherein the sintered body has a flexural strength of 700 MPa or more.

19. The magnetic head according to claim 10, wherein the slider has a flying surface and a recess part for introducing air, and the recess part has a surface having an arithmetic mean height Ra of 20 nm or less.

20. A recording medium driving device comprising:
the magnetic head according to any of claims 10 to 19;
a recording medium having a magnetic recording layer in which information is recorded and reproduced by the magnetic head; and
a motor driving the recording medium.
